(19) United States
(12) Patent Application Publication
(10) Pub. No.: US 2021/0054968 A1
(43) Pub. Date: Feb. 25, 2021

(54) Oil Drip Pan Assembly

(71) Applicant: Timothy Crombie, Naperville, IL (US)

(72) Inventor: Timothy Crombie, Naperville, IL (US)

(21) Appl. No.: 16/546,947

(22) Filed: Aug. 21, 2019

(51) Int. Cl. F16N 31/00

(52) U.S. Cl. CPC F16N 31/006

(57) ABSTRACT

The present invention is directed to an oil drip pan assembly easily affixed to the undercarriage of a vehicle that catches oil as it drips thereby preventing the oil from reaching the ground. The assembly includes an oil drip pan and an access panel. The access panel covers an access aperture in the oil pan which allows for access to the undercarriage of the vehicle for performance of oil changes without removal of the entire oil drip pan assembly. The access panel includes water weep holes and a selectively oil absorbent mat to expel water and retain oil.

### FIELD OF THE INVENTION

This invention relates to automotive accessories, specifically to an attachment for the undercarriage of a vehicle for collection of oil drippings from the engine or oil pan of a vehicle. The present invention collects oil before it drips onto the ground thereby preventing or reducing staining of pavement, reducing hazardous road conditions due to oil on wet pavement, and reducing the environmental hazard caused by dripped oil.

### BACKGROUND OF THE INVENTION

Most cars and trucks drip oil from the underside of the vehicle after 80,000-100,000 miles. Some cars and trucks drip oil before even reaching this mileage. Oil drips while the car is running as well as after it is turned off and parked. Oil drips consistently from the lowest point of the undercarriage and therefore drips from a similar area on each particular vehicle. Repairs to the vehicle can be expensive and many times don't fully resolve the problem or stop the drip. Owners of vehicles, high mileage vehicles especially, may be reluctant to spend money on expensive repairs. There are certain vehicle makes, models and years which are notorious for oil drips. Dripped oil can permanently stain pavement, driveways, and garages. Dripped oil can also cause a hazardous road condition on wet pavement and eventually runs off into streams, rivers, lakes, and groundwater causing an environmental hazard.

Use of auxiliary oil drip pans are known in the art. Known prior art includes U.S. Pat. Nos. 3,653,459; 3,918,542; and 6,378,639. These prior art devices have shortcomings, including: (1) pooling of a water and oil mixture that can bypass any absorbent material present and leak out onto the ground, (2) the device must be removed to perform vehicle maintenance such as an oil change, and (3) oil is held too close to warm parts of the vehicle creating a fire hazard. These shortcomings, among others, are addressed in the invention described herein.

### SUMMARY OF THE INVENTION

The present invention teaches an inexpensive oil drip pan assembly, easily affixed to the undercarriage of a vehicle using existing attachment points on the vehicle, which catches oil as it drips thereby preventing it from reaching the ground. The oil drip pan is highly effective in catching oil as it drips, due to a custom design for each particular vehicle or family of related vehicles, i.e., groups of vehicles having the same or similar undercarriages.

The oil drip pan assembly includes a drip pan and an access panel. The drip pan is shaped such that the liquid collected in the drip pan flows to the lowest point. The drip pan also has a removable or hinged access panel to allow easy oil changes without having to remove the entire assembly. Preferably, the access panel includes a selectively oil absorbent, replaceable mat secured to the top side of the access panel. The mat collects the oil and can be disposed of properly at regular vehicle oil change intervals. Additionally, the selectively oil absorbent mat optimally repels water, preventing the mat from getting saturated due to precipitation or other moisture on the roadway. Water weep holes with a raised border may be included through the access panel to allow water to be expelled from the drip pan while retaining oil in the mat and/or drip pan.

The drip pan is preferably formed from high-density polyethylene (HDPE) construction which facilitates oil flow to the lowest point of the drip pan due to Van Der

Waals forces and low surface tension between oil and HDPE. HDPE attracts oil allowing any water in the drip pan to temporarily bead on top of the oil rather than the oil floating on top of the water. This allows the water to flow to the access panel and exit the drip pan through the water weep holes while oil is retained on the drip pan or absorbed by the absorbent mat.

### DRAWINGS

FIG. 1 is a bottom view of an embodiment of the oil drip pan assembly,

FIG. 2A is a bottom view of an embodiment of the invention showing a hinged access panel in the open position,

FIG. 2B is a bottom view of an embodiment of the invention with the access panel removed,

FIG. 3 is an exploded view of a removable access panel,

FIG. 4 is a top view of an embodiment of the invention with a removable access panel,

FIG. 5 is a cross-section of an embodiment of the invention with a removable access panel,

FIG. 6 is a perspective view of a portion of an embodiment of the present invention detailing an embodiment having a removable access panel and utilizing the flange-socket engagement with the drip pan.

### DETAILED DESCRIPTION OF THE INVENTION

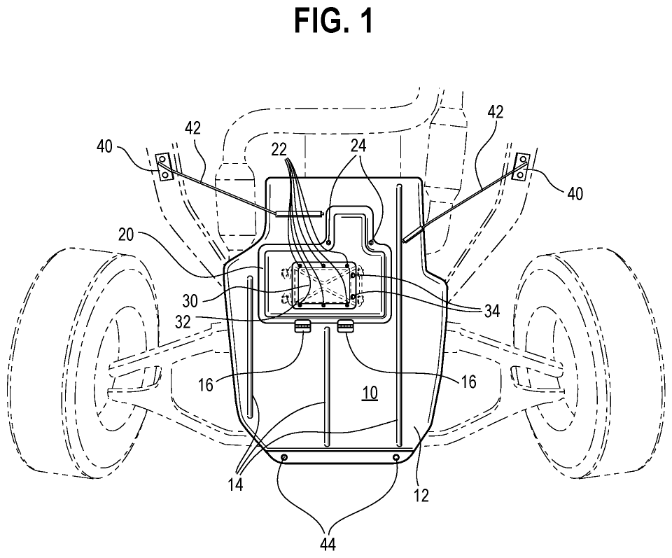

Referring to FIGS. 1-6, an oil drip pan assembly is depicted. The oil drip pan assembly comprises a drip pan and access panel. The drip pan has an access aperture such that when the drip pan is mounted on a vehicle, a portion of the undercarriage is exposed through the access aperture. Preferably, the exposed portion of the undercarriage includes a portion of the vehicle's oil pan to allow access to the vehicle's oil pan during routine oil changes without having to remove the drip pan. The access aperture is shaped such that when the oil drain plug is removed from the vehicle's oil pan and oil streams out during an oil change, the stream of oil falls through the access aperture and clear of the drip pan to avoiding splashing oil. The access panel covers the access aperture when it is in place on the drip pan and secured in a locked position. The drip pan is shaped such that the liquid collected in the drip pan flows to the lowest point, the lowest point preferably being the access panel. The shape may include a slight pitch to the drip pan to direct flow onto the access panel as well as a curved lip on the edge defining the access aperture. Preferably, the pitch of the drip pan does not significantly impact the ground clearance of the vehicle, if at all. The curved lip facilitates fluid flow onto the access panel. Preferably, the access panel has water weep holes through the lowest portion to allow water to exit the access panel. A slightly raised border on the water weep holes, preferably 0.1-0.2 mm, allows the water to exit through the weep holes while oil is retained on the access panel or absorbed into the mat.

When mounted to a vehicle, the top surface of the drip pan faces the vehicle and the bottom surface faces in a direction opposite the top surface; the front portion of the drip pan is closer to the front end of the vehicle while the rear portion of the drip pan is nearer the rear of the vehicle. Likewise, when the assembly is installed on a vehicle, the top surface of the access panel faces toward the undercarriage of the vehicle and the bottom surface faces in a direction opposite the top surface.

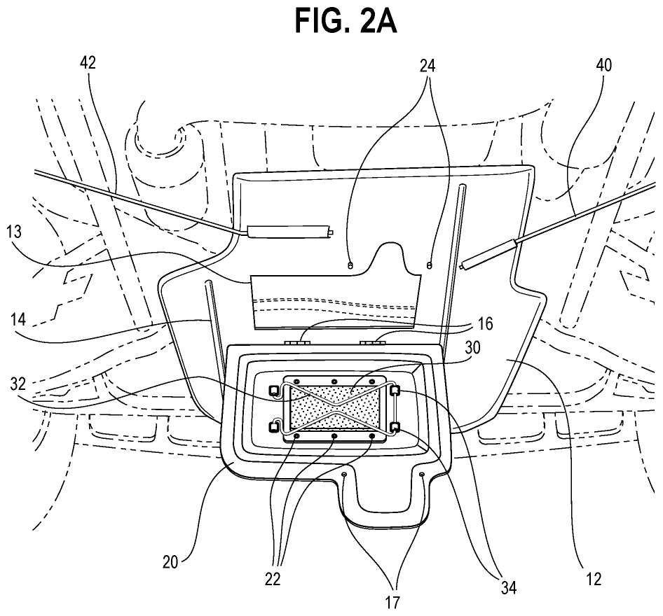

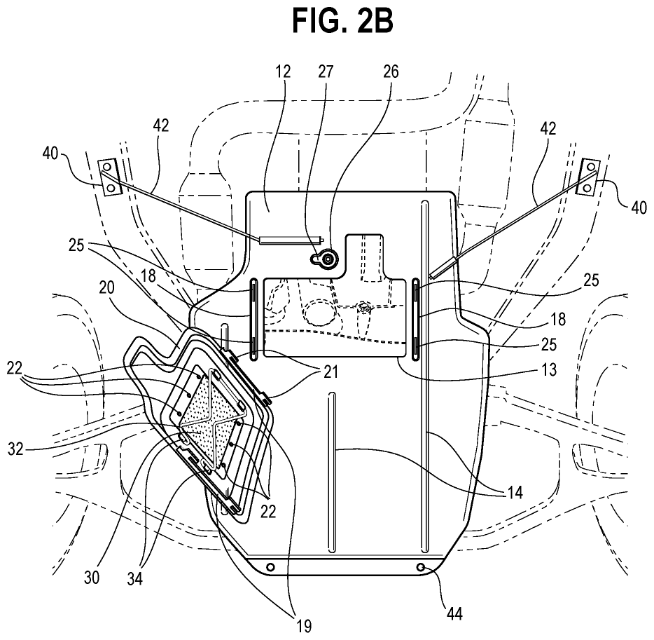

Various embodiments of the present invention are shown and described herein. In a preferred embodiment, the access panel is attached to the drip pan by hinges (see FIGS. 1 and 2A). In the open position, the access panel hangs from the drip pan exposing the access aperture and a portion of the undercarriage of the vehicle, preferably including the vehicle's oil pan, to allow for oil changes without removal of the drip pan. In the closed position, the access panel may be secured against the drip pan by pins, screws, bolts, or a lock member.

In another preferred embodiment, the access panel is removably held to the drip pan (see FIGS. 2B, 4-6). In the open position, the access panel is removed from the drip pan exposing the access aperture and a portion of the undercarriage of the vehicle. In this embodiment, the drip pan has at least one hollow, upstanding protuberance extending vertically from the top surface of the drip pan. The protuberance is preferably ventilated with notches. The protuberance defines a socket in the bottom surface of the drip pan. The socket is designed for receiving upstanding flanges on the top surface of the access panel. The flanges terminate in tabs. In the closed position, the tabs on the access panel flanges securely engage the notches on the protuberances of the drip pan. The access panel may be further secured in place by pins, screws, bolts, or a lock member.

As shown in FIG. 1, drip pan 12 is secured to the undercarriage of a vehicle (depicted in broken lines to show the environment) by support arms 42 which are secured to the vehicle by attachment brackets 40. Various known attachments are available for this purpose, such as brackets, latches, braces, and the like. Preferably, the assembly is configured for attachment using existing attachment points on the vehicle. Mounting apertures 44 are located through a front lip located on the front edge of drip pan 12 and allow for fasteners such as screws, bolts, or the like to secure the front portion of drip pan 12 to the vehicle. Ribs 14 extend longitudinally through drip pan 12 and provide additional structural support for drip pan 12. Access panel 20 is shown in the closed position and covers access aperture 13 (see FIG. 2A) and a portion of the bottom surface of drip pan 12. In the embodiment shown in FIGS. 1 and 2A, the front portion of access panel 20 is attached to the bottom surface of drip pan 12 by hinges 16. In the embodiment shown, the rear portion of access panel 20 is secured to the bottom surface of drip pan 12 by fasteners 24. Fasteners 24 can be any fasteners such as screws, bolts, pins, or the like. Other manners of securing access panel 20 to drip pan 12 when in the closed position are possible within the spirit and scope of the invention. Water weep holes 22 extend through access panel 20 and allow water collected on the top surface of access panel 20 to pass through the water weep holes 22 while oil is retained on the top surface of access panel 20. Oil absorbent mat 30 and mat restraint 32 are depicted in broken lines, as they are located on the top surface of access panel 20. Drip pan 12 is shaped and access panel 20 is contoured so that fluids retained in drip pan 12 flow to the lowest portion of access panel 20. Restraint attachment 34 secures mat restraint 32 to the top surface of access panel 20 (see FIGS. 2A, 2B, 4, and 5). In the embodiment shown, a portion of restraint attachment 34 passes through access panel 20 and is visible on the bottom surface of access panel 20.

FIG. 2A shows an embodiment of the present invention with access panel 20 attached to drip pan 12 via hinges 16. In this embodiment, in the open position, access panel 20 hangs from the bottom surface of drip pan 12 and exposes access aperture 13 and a portion of the undercarriage of the vehicle; in the closed position, access panel 20 covers access aperture 13 and a portion of the bottom surface of drip pan 12. In this embodiment, access panel 20 is secured to drip pan 12 in the closed position via fasteners 24. Depending upon the type of fasteners used, access panel 20 may have apertures 17 to engage fasteners 24. Oil absorbent mat 30 is shown on the lowest portion of the top surface of access panel 20. Mat restraint 32 holds mat 30 in place and is secured to access panel 20 via restraint attachments 34. Water weep holes 22 are spaced around the lowest portion of access panel 20, and extend through access panel 20. Water weep holes 22 have a raised border to facilitate absorption of oil by mat 30 while expelling water.

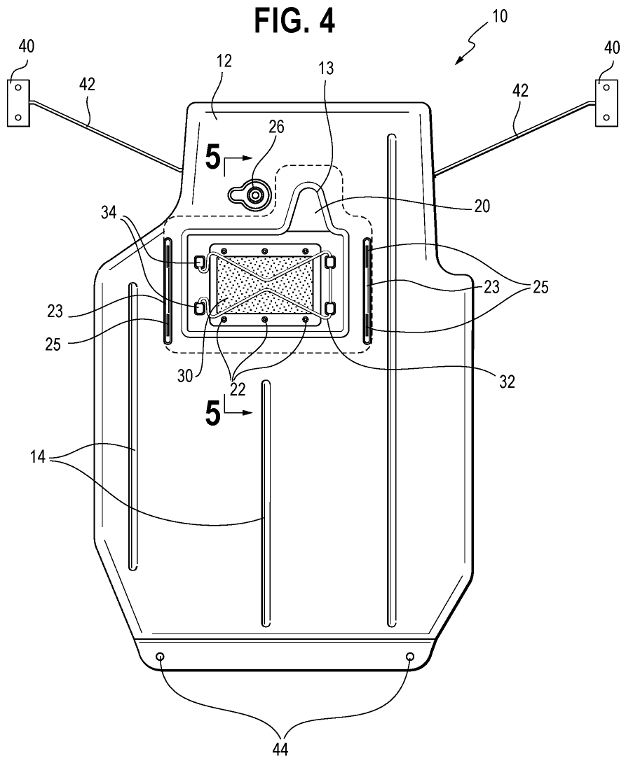

FIGS. 2B and 3-6 show an embodiment of the present invention wherein access panel 20 is removable. As shown in FIG. 2B, access panel 20, when in the open position, is removed from drip pan 12, exposing access aperture 13 and a portion of the undercarriage of the vehicle. Access panel 20 has flanges 19 which extend from the top surface of access panel 20. Flanges 19 terminate in tabs 21. The bottom surface of drip pan 12 has sockets 18 for receiving flanges 19. Sockets 18 are defined by hollow, upstanding protuberances 23 on the top surface of drip pan 12 (see FIGS. 4-6). Protuberances 23 are ventilated by notches 25 (see FIGS. 4-6). In the closed position, access panel 20 is held to drip pan 12 via engagement of tabs 21 of flanges 19 with notches 25 of protuberances 23. When engaged, tabs 21 pass through notches 25 and are suspended from the upper surface of protuberances 23 (see FIGS. 4-6). Preferably, as shown in this particular embodiment, access panel 20 is secured to drip pan 12 in the closed position by lock member 27 however; other manners of securing access panel 20 to drip pan 12 in the closed position are possible. Lock member 27 is housed within lock recess 26. Oil absorbent mat 30 is shown on the lowest portion of the top surface of access panel 20. Mat restraint 32 holds oil absorbent mat 30 in place and is secured to access panel 20 via restraint attachments 34. Restraint attachments 34 can be any suitable attachment which secures mat restraint 32 to the top surface of access panel 20 such as bolts, screws, hinges, or the like. Water weep holes 22 are spaced around the lowest portion of access panel 20, and extend through access panel 20.

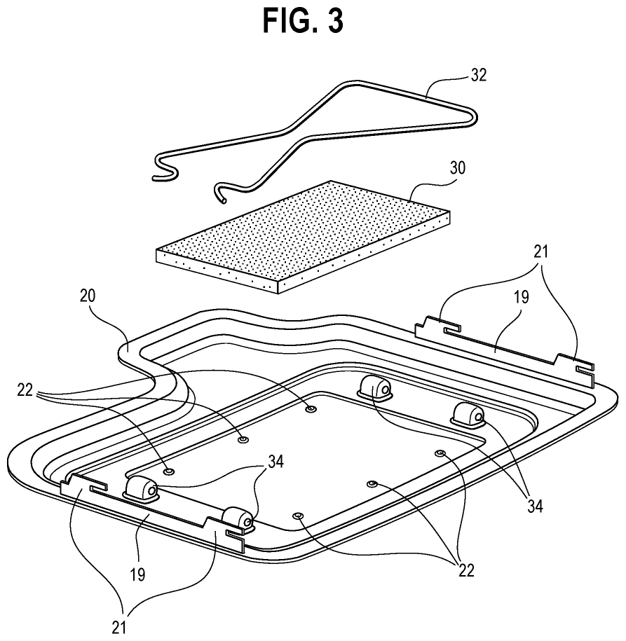

FIG. 3 shows an exploded view of a removable access panel 20 of the present invention using the flange-socket engagement with drip pan 12. As shown, access panel 20 has flanges 19 which terminate in tabs 21. In the closed position, access panel 20 is held to the bottom surface of drip pan 12 via engagement by tabs 21 of flanges 19 with notches 25 of protuberances 23. When engaged, tabs 21 pass through notches 25 and are suspended from the upper surface of protuberances 23 (see FIGS. 4-6). Water weep holes 22 are spaced around the lowest portion of access panel 20 and extend through access panel 20. Oil absorbent mat 30 is held to the top surface of the lowest portion of access panel 20 by mat restraint 32. Restraint attachments 34 are located on the top surface of access panel 20 and secure mat restraint 32 to the top surface of access panel 20. Mat restraint 32 can be any suitable shape and material such that mat 30 is securely held to the top surface of access panel 20 when mat restraint 32 is engaged with restraint attachments 34.

FIG. 4 shows a top view of an embodiment of oil drip pan assembly 10 with removable access panel 20 secured to the bottom surface of drip pan 12. Drip pan 12 is shown with support arms 42 and attachment brackets 40. Drip pan 12 has ribs 14 for increased structural support and mounting apertures 44 for facilitating attachment of the front portion of drip pan 12 to a vehicle. A portion of the top surface of access panel 20 is visible through access aperture 13. The broken line depicts the perimeter of access panel 20 beneath drip pan 12. Preferably, access panel 20 is at least slightly larger than access aperture 13 so that oil dripping from oil pan 12 onto access panel 20 falls well within the border of access panel 20. Water weep holes 22 are spaced about the lowest portion of access panel 20 and extend through access panel 20. Oil absorbent mat 30 sits on the lowest portion of the top surface of access panel 20. Oil absorbent mat 30 is held in place by mat restraint 32 which is secured to access panel 20 by restraint attachments 34. The embodiment shown in FIG. 4 uses the previously described flange-socket engagement between access panel 20 and drip pan 12. The top surface of drip pan 12 has hollow upstanding protuberances 23 which extend from the top surface of drip pan 12. The protuberances 23 define sockets 18 on the bottom surface of drip pan 12 (see FIG. 2B). Protuberances 23 are ventilated by notches 25. As shown in this embodiment, preferably, access panel 20 is secured in the closed position by lock member 27 (see FIG. 2B). Lock recess 26 provides a recess for housing lock member 27 (see FIG. 2B).

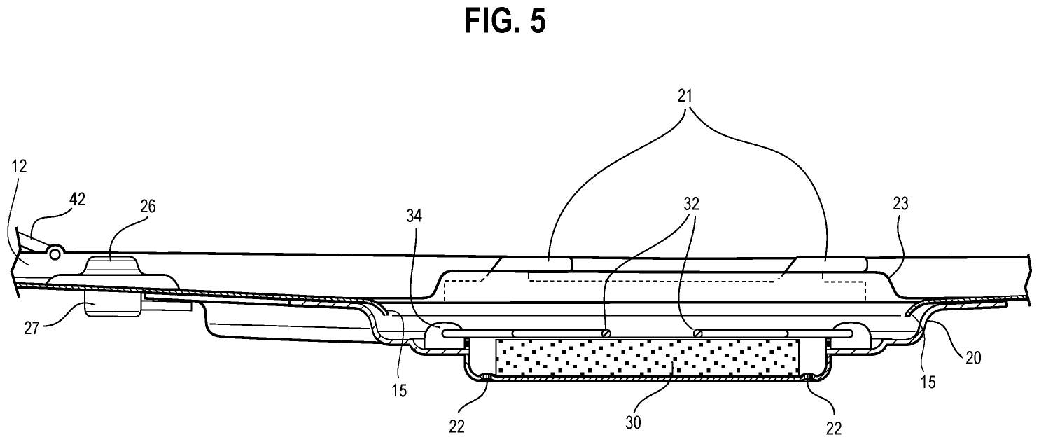

FIG. 5 shows a cross-section of an embodiment of oil pan assembly 10 having a removable access panel 20 as previously described. Drip pan 12 is attached to the undercarriage of a vehicle via support arm 42; support arm 42 is secured to the undercarriage of the vehicle by attachment bracket 40. Drip pan 12 has a slight pitch and curved lip 15 to facilitate fluid flow onto removable access panel 20. Curved lip 15 has a rounded shape angled toward access panel 20 and defines access aperture 13 (see FIGS. 2B, 4, and 6). Access panel 20 is slightly larger than access aperture 13 (see FIGS. 2B, 4, and 6) so that curved lip 15 overhangs access panel 20 such that oil on drip pan 12 drips into access panel 20. In the embodiment shown, access panel 20 is attached to the bottom surface of drip pan 12 via engagement of tabs 21 with notches 25 (see FIGS. 2B, 4, and 6) in protuberances 23. Flange 19 is depicted in broken lines to show its location within socket 18 defined by protuberance 23. Water weep holes 22 are shown spaced along the lowest portion of access panel 20 and extending through access panel 20. Oil absorbent mat 30 sits atop the lowest portion of the top surface of access panel 20. Mat restraint 32 holds oil absorbent mat 30 in place on the top surface of access panel 20. Mat restraint 32 is secured to access panel 20 via restraint attachments 34. In the embodiment shown, access panel 20 is held to the bottom surface of drip pan 12 in the closed position by lock member 27. Lock member 27 is housed within lock recess 26.

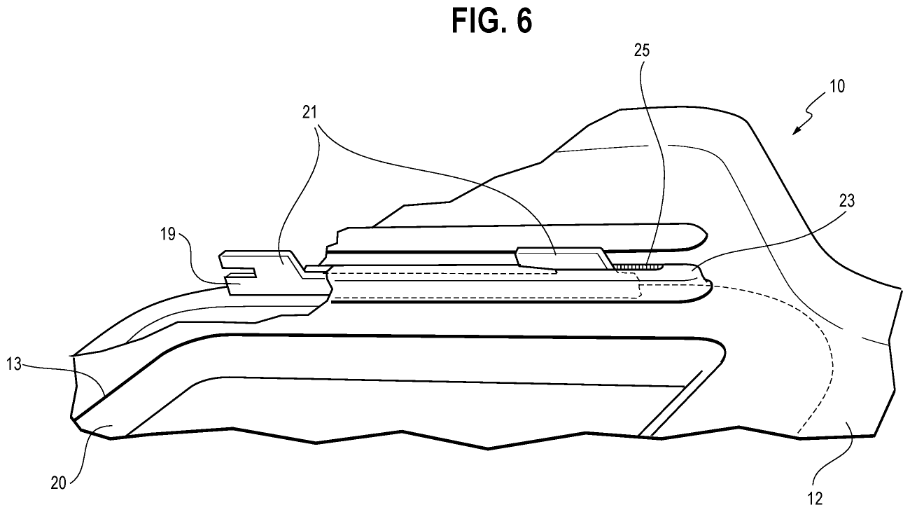

FIG. 6 shows a perspective view of a portion of an embodiment of oil pan assembly 10 with removable access panel 20, detailing the flange-socket engagement previously described. A portion of the top surface of access panel 20 is visible through access aperture 13 as well as where a portion of drip pan 12 has been removed. Access panel 20 has upstanding flange 19 which terminates in tabs 21. Flange 19 is received within socket 18 on the bottom surface of drip pan 12 (see FIG. 2B) defined by hollow, upstanding protuberance 23 on the top surface of drip pan 12. Protuberance 23 is ventilated by notches 25. Tabs 21 of flange 19 of access panel 20 are engaged with notches 25 of protuberance 23 to hold access panel 20 in place against the bottom surface of drip pan 12.

As shown in FIGS. 1-6, access panel 20 can be either easily removable, such as described above with the flange-socket engagement, or hinged to the bottom surface of drip pan 12 which allows easy, unencumbered access to change the oil and oil absorbent mat 30 as needed. In a preferred embodiment, access panel 20 swings away on hinges 16, as shown in FIGS. 1 and 2A, to allow access to the undercarriage for oil changes. In the closed position, access panel 20 may be secured either by fasteners 24 such as bolts, screws, pins, and the like, as shown in FIGS. 1 and 2A or by lock member 27 as shown in FIGS. 2B, 4, and 5.

In another preferred embodiment, access panel 20 is fully removable, as shown in FIGS. 2B, 3-6, to allow unencumbered access to at least a portion of the vehicle's undercarriage for oil changes. As in the previous embodiment, in the closed position, access panel 20 may be secured either by fasteners 24 such as bolts, screws, pins, and the like, as shown in FIGS. 1 and 2A, or in the alternative, access panel 20 may be secured by lock member 27 as shown in FIGS. 2B, 4, and 5.

The oil drip pan assembly of the present invention may be custom designed for particular vehicle makes, years, and models, or for particular vehicle families, i.e., groups of vehicles having the same or similar undercarriages, to improve performance and effectiveness of catching dripped oil and preventing airflow disruption while driving. The custom design also allows for easier installation utilizing existing undercarriage holes and attachment points without the need for any modification to the chassis or undercarriage of the vehicle.

The drip pan is of high-density polyethylene (HDPE) construction. HDPE is a thermoplastic polymer made from petroleum and is known for its large strength-to-density ratio. The density of HDPE can range from 930 to 970 km/m³. HDPE has little branching giving it strong intermolecular forces and tensile strength. It is impact resistant and has a high melting point. HDPE can withstand temperatures up to 120° C./248° F. for short periods yet once it reaches its melting point, HDPE can be easily molded. HDPE is also resistant to many different solvents.

The shape of the drip pan and use of HDPE construction thereof facilitates oil flow to lowest point due to Van Der Waals forces resulting in low surface tension between oil and HDPE. Water temporarily beads or pools on top of the oil despite oil having a lower density allowing water to exit the access panel while oil is retained. A selectively oil absorbent mat, such as a PIG® mat (available from New Pig Corporation, Tipton, Pa.), is placed on the lowest portion to absorb oil and repel water. A slightly raised border surrounding the water weep holes around the selectively oil absorbent mat facilitates absorption of oil into the mat, while expelling water due to water's naturally high surface tension. Pooling of a water and oil mixture that would potentially exit out through the weep holes bypassing the oil absorbent mat and onto the ground is avoided. Consequently, a shortcoming of other designs of auxiliary oil drip pans is successfully addressed.

The embodiments described herein are examples of some preferred embodiments. Other embodiments are feasible within the spirit and scope of the invention described herein.

I claim:

1. An oil drip pan assembly for attachment to an undercarriage of a vehicle comprising:
at least two support arms for securing the oil drip pan assembly to the undercarriage of the vehicle;
a drip pan for receiving oil from the undercarriage of the vehicle attached to the support arms, the drip pan having a top surface facing the undercarriage of the vehicle and a bottom surface facing in a direction opposite the top surface, wherein the drip pan has an access aperture, the access aperture exposing at least a portion of the undercarriage of the vehicle without removal of the drip pan; and
an access panel having a contoured top surface facing the undercarriage of the vehicle and a bottom surface facing in a direction opposite the top surface, with the contoured top surface of the access panel having a lowest portion, wherein, when in a closed position, the access panel covers the access aperture, and when in an open position, the access panel exposes the access aperture, the access panel further comprising:
water weep holes spaced along the lowest portion of the access panel;
a selectively oil absorbent mat on the top surface of the access panel; and
a restraint for removably securing the selectively oil absorbent mat to the top surface of the access panel.

2. The oil drip pan assembly of claim 1 wherein the drip pan is of high-density polyethylene construction.

3. The oil drip pan assembly of claim 2 wherein the water weep holes have a raised border on the top surface of the access panel.

4. The oil drip pan assembly of claim 3 wherein the access panel is attached to the drip pan by at least one hinge.

5. The oil drip pan assembly of claim 4 wherein the access panel is further secured to the drip pan in a closed position with fasteners such as studs, pins, screws, or bolts.

6. The oil drip pan assembly of claim 4 wherein the access panel is further secured to the drip pan in a closed position with a lock member.

7. The oil drip pan assembly of claim 3 wherein the drip pan has a curved lip defining the access aperture.

8. The oil drip pan assembly of claim 3 wherein:
the access panel has at least one upstanding flange extending from the top surface of the access panel, said flange having at least one tab, and
the drip pan has an upstanding, hollow protuberance extending from the top surface of the drip pan, said protuberance defining a socket on the bottom surface of the drip pan, said socket being configured to receive said flange, wherein said protuberance is ventilated with at least one notch, said notch being configured to engage said tab of said flange.

9. The oil drip pan assembly of claim 8 wherein the access panel is further secured to the drip pan in a closed position with fasteners such as studs, pins, screws, or bolts.

10. The oil drip pan assembly of claim 8 wherein the access panel is further secured to the drip pan in a closed position with a lock member.

11. The oil drip pan assembly of claim 8 wherein the drip pan has a curved lip defining the access aperture.

12. An oil drip pan assembly for attachment to an undercarriage of a vehicle comprising:
at least two support arms for securing the oil drip pan assembly to the undercarriage of the vehicle;
a drip pan for receiving oil from the undercarriage of the vehicle, the drip pan being attached to the support arms, and having a top surface facing the undercarriage of the vehicle and a bottom surface facing in a direction opposite the top surface, wherein the drip pan has an access aperture, said access aperture allowing for access to at least a portion of the undercarriage of the vehicle without removal of the drip pan; and
an access panel having a contoured top surface facing the undercarriage of the vehicle and an bottom surface facing in a direction opposite the top surface, with the top surface of the access panel having a lowest portion, wherein when in a closed position said access panel covers said access aperture and when in an open position said access panel exposes said access aperture, said access panel further comprising:
water weep holes spaced along the lowest portion of the access panel;
a selectively oil absorbent mat; and
a restraint for removably securing the selectively oil absorbent mat to the lowest portion of the top surface of the access panel, wherein the access panel is attached to the drip pan by at least one hinge and is secured to the drip pan in a closed position with fasteners such as studs, pins, screws, or bolts.

13. The oil drip pan assembly of claim 12 wherein the drip pan has a curved lip defining the access aperture.

14. An oil drip pan assembly for attachment to an undercarriage of a vehicle comprising:
at least two support arms for securing the oil drip pan assembly to the undercarriage of the vehicle;
a drip pan for receiving oil from the undercarriage of the vehicle, the drip pan being attached to the support arms, and having a top surface facing the undercarriage of the vehicle and a bottom surface facing in a direction opposite the top surface, wherein the drip pan has an access aperture, said access aperture allowing for access to at least a portion of the undercarriage of the vehicle without removal of the drip pan; and
an access panel having a contoured top surface facing the undercarriage of the vehicle and a bottom surface facing in a direction opposite the top surface, wherein when in a closed position said access panel covers said access aperture and when in an open position said access panel exposes said access aperture, said access panel further comprising:
water weep holes spaced along the lowest portion of the access panel;
a selectively oil absorbent mat; and
a restraint for removably securing the selectively oil absorbent mat to the top surface of the access panel, wherein the access panel has at least one flange extending from the top surface of the access panel, said flange having at least one tab,
said drip pan further comprising an upstanding hollow protuberance extending from the top surface of the drip pan, said protuberance defining a socket, said socket being configured to receive said flange, wherein said protuberance is ventilated with at least one notch, said notch being configured to engage said tab of said flange, and
the access panel being secured to the drip pan in a closed position with a lock member.

15. The oil drip pan assembly of claim 14 wherein the drip pan has a curved lip defining the access aperture.
